(19) United States
(12) Patent Application Publication
(10) Pub. No.: US 2004/0206023 A1
(43) Pub. Date: Oct. 21, 2004

(54) Backer rod material and joint construction for building components

(76) Inventor: P. Michael Collins, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/842,886

(22) Filed: May 11, 2004

Related U.S. Application Data
(63) Continuation-in-part of application No. 10/602,198, filed on Jun. 24, 2003.
(60) Provisional application No. 60/391,333, filed on Jun. 25, 2002.

(51) Int. Cl. E06B 1/04; E04B 2/00; E04B 5/00; E04B 9/00

(52) U.S. Cl. 52/204.1

(57) ABSTRACT

An efficient and reliable installation for a water tight and an aesthetically pleasing transition between adjacent building or construction components is provided with use of a backer rod material for placement between adjacent building or construction components for subsequent caulking. A closed cell foam backer rod material includes a terminal end portion of the backer rod joined to a remainder thereof by a frangible connection or perforated joint. The frangible connection or joint in the backer rod is nonlinear or arcuate-shaped to provide a crown-shaped or convex-shaped backer rod surface to receive the caulking compound to finish the joint. After the backer rod material is installed into the joint, the terminal end portion of the backer rod is removed by being torn along the frangible joint. A bead of caulk or similar finishing material is applied in the recess to provide a smooth and aesthetically pleasing transition from the frame to the wall. The convex or crown shape of the exposed surface of the backer rod material allows for and promotes integrity of the caulking compound during shifting, expansion and/or contraction of the adjacent building components relative to each other.

This is a continuation-in-part of U.S. patent application Ser. No. 10/602,198, filed Jun. 24, 2003 which claims the benefit of U.S. Provisional Patent Application Serial No. 60/391,333, filed Jun. 25, 2002, each of which is hereby incorporated by reference entirely.

### BACKGROUND OF THE INVENTION

This invention relates to backer rods used at joints between building or construction components and, more particularly, to backer rods used in association with window and door installations in a veneer/cavity wall system for proper transition between the window or door installation and the masonry veneer as well as other applications.

Wall systems having a masonry exterior are typically constructed of at least one vertical layer of masonry components and at least a second vertical layer of a material forming a back-up system. The back-up system may be constructed of lumber, light gauge steel studs or of a concrete masonry unit. The masonry and back-up system are typically bonded together by horizontal metallic ties spaced apart vertically. A space is often provided in such wall systems (e.g., cavity wall systems) between the masonry and back-up system for moisture drainage.

Problems often arise during the construction of a building or other structure, be it a cavity wall or other building system, in maintaining a proper transition between adjacent building or construction components. For example, the dimensioning of the window or door frame installed in the wall is frequently different and incompatible with the thickness, geometry and dimensions of the cavity wall construction. Caulk is often used in many joints, for example, along the wall jamb and header in an effort to provide a water tight seal and aesthetic transition to the window or door frame.

Commercial buildings have numerous lengthy joints between various components or surfaces. For example, slabs of marble are spaced apart by joints to allow for expansion and contraction. The joints must be sealed with caulking compound or other suitable material placed adjacent the exterior surface of the slabs. Backer rods, typically produced from polyethylene, are initially installed in the joint at a specified depth with the remaining portion of the joint from the backer-rod to the outside surface then being filled with caulking compound.

The typical practice in installing a backer-rod is to initially force the backer-rod into the joint and to then further force the backer-rod to the predetermined depth by means of forcing a putty knife against the rod. Use of such a tool does not provide accurate depth control of the backer-rod since the putty knife does not provide any means for measuring the depth of the slot or joint once the rod is installed. Further, many commercial buildings have thousands and thousands of linear feet of joints requiring an inordinate amount of time for the installation of the backer-rod to the predetermined depth. If the joint is not properly constructed, the caulk may fail or separate from the adjacent components thereby jeopardizing the fluid impermeable joint when the components expand or contract in response to changes in the weather.

Municipal building codes differ from locale to locale and different window or door frame profiles from the variety of manufacturers make predictable spacing for caulk application nearly impossible. As a result, the detailing and finishing work required for proper transition between building or construction components such as the installation of a window or door into a masonry veneer or cavity wall construction is typically very labor intensive, non-uniform and highly dependent upon the skill and experience of the particular contractor or tradesman performing the installation. Because of the importance and wide spread popularity of concrete and masonry structures, a better method for proper and consistent transition between adjacent building components is needed.

### SUMMARY OF THE INVENTION

This invention provides a solution to these and other problems in the art and allows an efficient and reliable installation for a water tight and an aesthetically pleasing transition between adjacent building or construction components, including, but not limited to, the transition from the window or door frame to the masonry veneer. Generally, this invention includes a novel backer rod material for placement between adjacent building or construction components for subsequent caulking.

In one embodiment, this invention includes a surround device installed adjacent the window frame or door frame and such backer rod material to provide a proper transition from the frame to the wall structure. In one embodiment, the surround device has a generally L-shaped configuration with a first leg of the device being mounted to the outer face of the inner wall of the cavity wall construction and in the cavity between the spaced walls. The second leg of the surround device projects generally perpendicularly from the first leg and from the inner wall toward the outer wall adjacent the window or door frame. Additionally, in one embodiment, a closed cell foam backer rod material in which a terminal end portion of the backer rod is joined to a remainder thereof by a frangible connection or perforated joint is included. Advantageously, the frangible connection or joint in the backer rod is non-linear or arcuate-shaped to provide a crown-shaped or convex-shaped backer rod surface to receive the caulking compound to finish the joint. After the surround device is installed adjacent to the frame and the inner and outer wall construction is complete, the terminal end portion of the backer rod is removed by being torn along the frangible joint. After the terminal end portion is removed, a recess is exposed at a juncture of the building components. A bead of caulk or similar finishing material is applied in the recess to provide a smooth and aesthetically pleasing transition from the frame to the wall. Additionally, the juncture between the frame and the wall is sealed by the caulk bead to inhibit and/or prevent the entry of moisture or other foreign material. Additional embodiments of the invention are also disclosed.

The convex or crown shape of the exposed surface of the backer rod material allows for and promotes integrity of the caulking compound during shifting, expansion and/or contraction of the adjacent building components relative to each other. Advantageously, the backer rod material is readily adaptable for use with a wide variety of building and construction applications, including window and door frame designs and construction specifications without requiring highly skilled or specialized installation and construction techniques.

### BRIEF DESCRIPTION OF THE DRAWINGS

The objectives and features of the invention will become more readily apparent from the following detailed description taken in conjunction with the accompanying drawings in which:

FIG.1 is an exemplary view of a window installation in a masonry cavity wall showing in cross-sectional view a transition between a wall jamb and a window frame, including backer rod material, according to one embodiment of this invention;

FIG. 2 is an enlarged cross-sectional view of the encircled area 2 of FIG. 1 showing the finished transition between the wall jamb and window frame;

FIG. 2A is a view similar to that of FIG. 2 showing the joint during movement of the adjacent building components; and

FIG. 3 is a view similar to FIG. 2A of a prior art backer rod and the associated joint during movement of the adjacent building components.

### DETAILED DESCRIPTION OF THE INVENTION

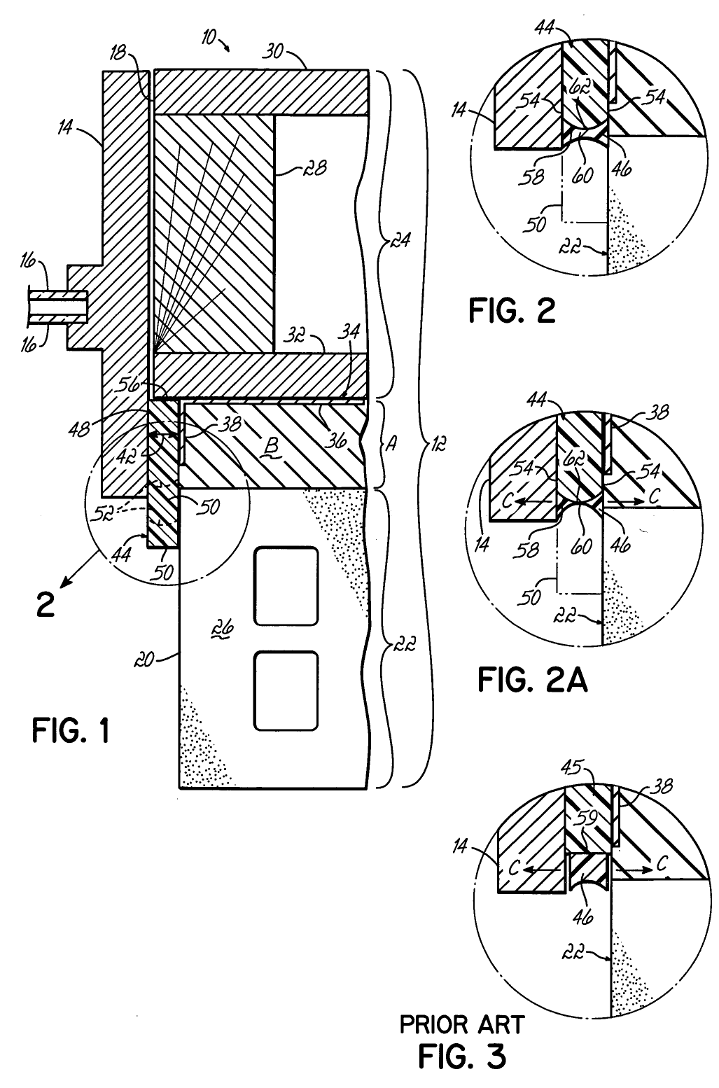

Referring to FIG. 1, an exemplary window installation 10 in a masonry wall 12 is shown. The window installation 10 includes a perimeter window frame 14, one or more window panes 16, and a window opening 18 in the wall defined by a pair of jambs 20 and a header (not shown) above and a sill (not shown) below the window frame 14. Although one example of a window installation is shown in FIG. 1, this invention is readily applicable for a variety of window installations, frame designs, doors and other openings or interruptions in the masonry wall. Moreover, this invention is not limited to window or door installations and is readily applicable for transitions, joints or junctures between any adjacent building or construction components.

As the environment for one application of this invention, the masonry wall 12 for the exterior of a building includes an outer wall 22 of masonry or brick veneer and an insulated interior wall 24. The brick veneer outer wall 22 is constructed from bricks or blocks 26 arranged in a vertical pattern. The brick veneer 22 is built up by placing one layer of bricks 26 over another layer. The spaces between adjacent bricks 26 and between adjacent layers of bricks are filled with mortar (not shown). Alternatively, the veneer 26 may be stone or other masonry components.

The interior wall 24 includes wood framing studs 28, dry wall 30, and outer sheathing material 32. Other materials may be used as is well known in the art. In any event, the building wall 12 is constructed so that there is a small cavity or airspace A between the back side of the outer wall 22 and the outer surface of the interior wall 24. The airspace A between the back side of the outer wall 22 and the surface of the interior wall 24 is usually at least about one to two inches deep, although the exact dimension may vary depending upon the nature of the construction.

Referring to FIGS. 1-2A, one embodiment of a jamb/header surround device 34 is shown installed in the wall 12 to provide a proper transition from the window frame 14 to the wall 12. The jamb/header surround 34 is installed in the jambs 20 of the window opening 18 adjacent to the corresponding portions of the window frame 14. In one embodiment, the surround device 34 is generally L-shaped, in which a first leg 36 of the device 34 confronts an outer face of the inner wall 24, and a second leg 38 of the device 34 projects generally perpendicular to the plane of the wall 12 and is juxtaposed to the outer wall 22 at the window opening 18 to provide a transition from the window frame 14 to the wall 12. As is readily apparent, particularly from FIG. 1, the forward-most edge 40 of the window frame 14 is recessed relative to the front face of the outer wall 22. Therefore, a proper transition from the window frame 14 to the wall 12 that is effectively sealed against wind, rain, and other elements as well as aesthetically pleasing is often difficult. The wide variety, sizes and configurations of window frames 14 available from various manufacturers increases the complexity and difficulty with providing a proper transition from the window frame 14 to the wall 12. More details and alternative embodiments of the surround device 34 are in U.S. patent application Ser. No. 10/602,198, filed Jun. 24, 2003 and hereby incorporated by reference entirely.

A recess 42 is formed between the adjacent components 12, 14. Backer rod material 44 which is open or closed cell foam or similar material is inserted in the recess 42 and a bead of caulk 46 is applied between the frame 14 and the adjacent portion of wall 12 to provide a proper finished transition, and thereby substantially cover and seal the recess 42.

The joint of this invention also allows for expansion and contraction of one component, such as the window frame 14 relative to another component, such as the wall 12 during a variety of climatic conditions. The backer rod 44 and caulk 46 accommodate expansion and contraction of the adjacent components 12, 24 relative to each other.

Referring to FIGS. 1, 2 and 2A, the backer rod material 44 according to one embodiment of this invention includes a main body portion 48 and one or more distal, terminal end portions 50 serially connected to the body portion 48 by frangible joints or connections 52. Advantageously, each frangible joint or connection 52 is shaped arcuately or non-linearly relative to the planar, spaced, side edges 54 of the backer rod 44. A planar end surface 56 is spaced from the terminal portions 50.

As a result of the arcuate-shaped frangible connection 52 between the body portion 48 and the adjacent end portions 50 of the backer rod 44, when the backer rod 44 is inserted into the recess 42 between adjacent building components, such as the window frame 14 and adjacent wall 12, one or more of the terminal end portions 50 is severed or removed from the body portion 48 along the appropriate arcuate-shaped frangible connection 52. As a result, the backer rod 44 remaining in the recess 42 includes a crown or convex-shaped surface or edge 58. Depending upon the geometry of the joint, the back rod 44 may include any number of serially connected terminal end portions 50 and the appropriate frangible connections 52 as shown in FIG. 1. The appropriate number of the terminal end portions 50 are removed to present the recessed convex or crown-shaped surface 58 as shown in FIG. 2.

After the terminal end portion(s) 50 is/are removed from the body portion 48 of the backer rod 44, the appropriate bead of caulk 46 is applied to the crown or convex-shaped surface 58 of the backer rod 44 to provide a finished transition between the adjacent building or construction components 12, 14. Advantageously, the crown or convex-shaped surface 58 of the backer rod material 44 accommodates expansion, contraction and/or general movement of the adjacent building components as shown by arrows C in FIG. 2A without separation of the caulk 46 from the building components 12, 14 thereby avoiding deterioration of the joint.

Specifically, as the adjacent components 12,14 contract or move away from each other as shown by arrows C, the crown or convex-shaped surface 58 of the backer rod 44 promotes narrowing or necking down of the thinnest portion 60 of the caulk material 46 adjacent an apex 62 of the crown-shaped edge 58 as shown by comparing FIGS. 2 and 2A. This crowing or necking of the caulk material 46 along the apex 62 of the backer rod convex edge 58 advantageously avoids separation of the caulk 46 from the adjacent building components 12, 14, which occurs with the prior art arrangement of FIG. 3 wherein the backer rod 45 has a generally linear or planar edge 59. In that the hour glass-shaped configuration of the caulk 46 in FIG. 2 provides for stretching of the caulk in the narrow middle portion 60 of the bead 46, when the components 12, 14 adjacent the caulk 46 move as shown in FIG. 2A, the narrow middle portion of the caulk 60 adjacent the apex 62 of the crown edge 58 further necks down avoiding separation of the caulk 46 at the interface with the adjacent building components 12, 14. Moreover, the back rod 44 having one or more frangible connections 52 each which provide a crown or convex-shaped edge 58 allows for easy, convenient and reliable installation of the backer rod 44 during construction. The appropriate number of end portions 50 are removed from the body portion 48 to provide the recess 42 of the proper depth for application of the caulk 46.

The backer rod material 44 may be used generally at the joint between two building/construction components 12, 14. The two components may, for example, be produced from marble and provide the exterior skin of a office building. Components are spaced apart to provide a control joint for contraction and expansion of the materials. Thus, a joint is provided between both components and opens outwardly through the front exterior surfaces of components. The backer rod may be polyethylene and positioned in the recess 42 and has a most forward located surface 58 located a distance from the forward surfaces of components 12, 14 to define the recess 42. Typically, the depth of the recess 42 should be one-half the width of the spacing between components 12, 14.

From the above disclosure of the general principles of the present invention and the preceding detailed description of at least one preferred embodiment, those skilled in the art will readily comprehend the various modifications to which this invention is susceptible for example, the backer rod material of this invention can be used at the joint between any adjacent building or construction components, including window and door frames, with or without a surround device as shown in one embodiment herein. Therefore, I desire to be limited only by the scope of the following claims and equivalents thereof.

I claim:

1. A backer rod adapted to be placed between a pair of adjacent components and have caulk applied thereto for forming a joint between the components, the backer rod comprising:
a main body portion with a longitudinal axis;
a terminal portion; and
a primary frangible connection joining the main body portion and the terminal portion together, the primary frangible connection being adapted to be severed to remove the terminal portion from the main body portion and the main body portion being adapted to receive the caulk thereon to form the joint between the adjacent components.

2. The backer rod of claim 1 further comprising a plurality of the terminal portions and at least one secondary frangible connection each of which joins one of the terminal portions to an adjacent terminal portion.

3. The backer rod of claim 2 wherein each of the terminal portions is serially connected to the adjacent terminal portion via one of the secondary frangible connections.

4. The backer rod of claim 1 wherein the primary frangible connection is generally parallel to the longitudinal axis of the main body portion.

5. The backer rod of claim 1 wherein a cross-sectional configuration of the primary frangible connection is non-linear.

6. The backer rod of claim 5 wherein the cross-sectional configuration is generally arcuate.

7. The backer rod of claim 6 wherein a surface of the main body portion adjacent to the frangible connection and which is exposed once the terminal portion is severed from the main body portion via the primary frangible connection is convex shaped.

8. The backer rod of claim 5 wherein the cross-sectional configuration of the frangible connection is symmetric.

9. The backer rod of claim 1 wherein the main body portion includes at least one generally planar surface.

10. The backer rod of claim 9 further comprising:
a plurality of the generally planar surfaces on the main body portion, two of the generally planar surfaces are generally parallel and spaced from one another and adjacent to the frangible connection and another of which is spaced from the frangible connection and generally perpendicular to the other two planar surfaces.

11. A backer rod adapted to be placed between a pair of adjacent components and have caulk applied thereto for forming a joint between the components, the backer rod comprising:
a main body portion with a longitudinal axis and a plurality of generally planar surfaces, two of which are generally parallel and spaced from one another and another of which is generally perpendicular to the other two planar surfaces;
a plurality of terminal portions; and
a plurality of arcuate frangible connections each of which joins one of the terminal portions and the main body portion to an adjacent terminal portion, each frangible connection being adapted to be severed to remove at least one of the terminal portions from the main body portion and to receive the caulk thereon to form the joint between the adjacent components;
wherein each of the terminal portions is serially connected to the adjacent terminal portion via one of the frangible connections and each frangible connection is generally parallel to the longitudinal axis of the main body portion.

12. An arrangement comprising:
a pair of adjacent components;
a backer rod positioned between the adjacent components;
a bead of caulk applied to the backer rod and contacting the adjacent components to form a joint there between;
wherein the backer rod further comprises:
(a) a main body portion with a longitudinal axis;
(b) a terminal portion; and
(c) a primary frangible connection joining the main body portion and the terminal portion together, the primary frangible connection being adapted to be severed to remove the terminal portion from the main body portion and the main body portion being adapted to receive the caulk thereon to form the joint between the adjacent components.

13. The arrangement of claim 12 further comprising a plurality of the terminal portions and at least one secondary frangible connection each of which joins one of the terminal portions to an adjacent terminal portion.

14. The arrangement of claim 13 wherein each of the terminal portions is serially connected to the adjacent terminal portion via one of the secondary frangible connections.

15. The arrangement of claim 12 wherein the primary frangible connection is generally parallel to the longitudinal axis of the main body portion.

16. The arrangement of claim 12 wherein a cross-sectional configuration of the primary frangible connection is generally arcuate.

17. The arrangement of claim 16 wherein a surface of the main body portion adjacent to the frangible connection and which is exposed once the terminal portion is severed from the main body portion via the primary frangible connection is convex shaped.

18. The arrangement of claim 16 wherein the cross-sectional configuration of the frangible connection is symmetric.

19. The arrangement of claim 1 wherein the main body portion includes at least one generally planar surface.

20. The arrangement of claim 12 wherein one of the components is a wall and the other of the components is a frame bordering an opening in the wall.

21. A method of constructing a joint between two adjacent components, the method comprising the steps of:
inserting a backer rod between the two adjacent components;
removing a terminal portion of the backer rod along a frangible connection with a remainder of the backer rod; and
applying a bead of caulk onto the remainder of the backer rod and in contact with the two adjacent components.

22. The method of claim 21 wherein the removing step exposes a convex shaped surface of the backer rod.

23. The method of claim 22 wherein applying the bead of caulk step forms and hour glass-shaped caulk configuration in cross-section.
